(19) United States
(12) Patent Application Publication
(10) Pub. No.: US 2013/0191102 A1
(43) Pub. Date: Jul. 25, 2013

(54) Apparatus and Method for Simulating a Target

(71) Applicants: Chi-Ho Chang, New Taipei City (TW); Chih-Yuan Wu, Penghu County (TW); Ming-Hung Hsu, Taoyuan County (TW); Piao Jung Liu, New Taipei City (TW)

(72) Inventors: Chi-Ho Chang, New Taipei City (TW); Chih-Yuan Wu, Penghu County (TW); Ming-Hung Hsu, Taoyuan County (TW); Piao Jung Liu, New Taipei City (TW)

(73) Assignee: Chung-Shan Institute of Science and Technology, Armaments, Bureau, Ministry of National Defense, Taoyuan County (TW)

(21) Appl. No.: 13/437,191

(22) Filed: Apr. 2, 2012

(30) Foreign Application Priority Data
Jan. 19, 2012 (TW) 101102087

(51) Int. Cl. G06G 7/62

(52) U.S. Cl. 703/13

(57) ABSTRACT

An apparatus for simulating a target at a variable distance and speed includes a transceiver, isolators, a signal delayer, a wave mixer and a signal attenuator. The isolators receive a signal from the transceiver. The signal delayer receives the signal from the isolators and accordingly simulates a delay value at a distance. The wave mixer is connected to the signal delayer. A Doppler shift is introduced into the apparatus through the wave mixer. The signal attenuator is connected to the isolators and the wave mixer for producing an adjustable attenuated signal corresponding to a variable distance.

### BACKGROUND OF INVENTION

1. Field of Invention

The present invention relates to an apparatus and method for simulating a target and, more particularly, to an apparatus and method for simulating a target at a variable distance and speed.

2. Related Prior Art

Wireless communication is a well developed technology. It is a common practice to use radars for detecting and tracking targets. An FMCW radar emits a detective signal and receives a reflective signal bounced back from a target. A delay exists between the detective and reflective signals dependent on the distance of the target from the FMCW radar. As scanning is executed with an upper swept signal, there is a first beat frequency fa between the detective and reflective signals. As scanning is executed with a lower swept signal, there is a second beat frequency fb between the detective and reflective signals. Where there is a relative shift between the first and second beat frequencies fa and fb, i.e., a Doppler shift, the Doppler shift is used to calculate the speed of the target relative to the FMCW radar. Thus, the FMCW radar includes a physical lagging device to simulate the movement of the target.

Simulation of a detective signal for a target at a long distance and high speed requires a large place for accommodating a bulky apparatus under a lot of limitations. Moreover, the apparatus placed outdoors is vulnerable to the weather and environment. Hence, it is difficult to use the apparatus to provide simulative signals for various distances in various environments. The FMCW radar is often used to detect the distance and speed of the target. In a simulative test, a high pole is used to measure the place and apparatus. It is hence important to figure out how to simulate and detect a target at a long distance and high speed to provide parameters for the FMCW radar.

The present invention is therefore intended to obviate or at least alleviate the problems encountered in prior art.

### SUMMARY OF INVENTION

It is an objective of the present invention to provide an apparatus for simulating a target at a variable distance and speed.

To achieve the foregoing objective, the apparatus includes a transceiver, isolators, a signal delayer, a wave mixer and a signal attenuator. The isolators receive a signal from the transceiver. The signal delayer receives the signal from the isolators and accordingly simulates a delay value for a distance. The wave mixer is connected to the signal delayer. A Doppler shift is introduced into the apparatus via the wave mixer. The signal attenuator is connected to the isolators and the wave mixer for producing an adjustable attenuated signal corresponding to a variable distance.

In an aspect, the signal delayer includes a microwave switch and a power combiner.

In another aspect, the microwave switch is a 1-to-4 microwave switch for connection to four wires corresponding to four different distances.

In another aspect, the power combiner is a 4-to-1 power combiner. In another aspect, the wave mixer receives the signal from the signal delayer, wherein a Doppler shift is introduced into the apparatus via the wave mixer.

In another aspect, the signal attenuator includes two programmable attenuation units.

In another aspect, one of the programmable attenuation units is set to be 10 dB per notch while the other programmable attenuation unit is set to be 1 dB per notch.

It is another objective of the present invention to provide a method for simulating a target at a variable distance and speed.

To achieve the foregoing objective, the method includes the step of providing an apparatus with a transceiver, isolators, a signal delayer and a signal attenuator, the step of initializing the apparatus, the step of setting parameters with the apparatus to simulate the distance and speed of the target, the step of using the transceiver to transmit a signal, the step of using the isolators to facilitate the transceiver to transmit the signal in a one-way directional manner, and the step of processing the signal to simulate the movement of the target.

In an aspect, the parameters include the distance, speed and acceleration of the target.

In another aspect, the step of processing the signal includes the step of providing a signal delayer and a signal attenuator for processing the signal.

In another aspect, the step of processing the signal includes the step of processing a Doppler shift.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a block diagram of an apparatus for simulating a target at a variable distance and speed according to the first embodiment of the present invention;

FIG. 2 is a more detailed block diagram of the apparatus for simulating a target at a variable distance and speed shown in FIG. 1; and

FIG. 3 is a flow chart of a method for simulating a target at a variable distance and speed according to the second embodiment of the present invention.

### DETAILED DESCRIPTION OF EMBODIMENTS

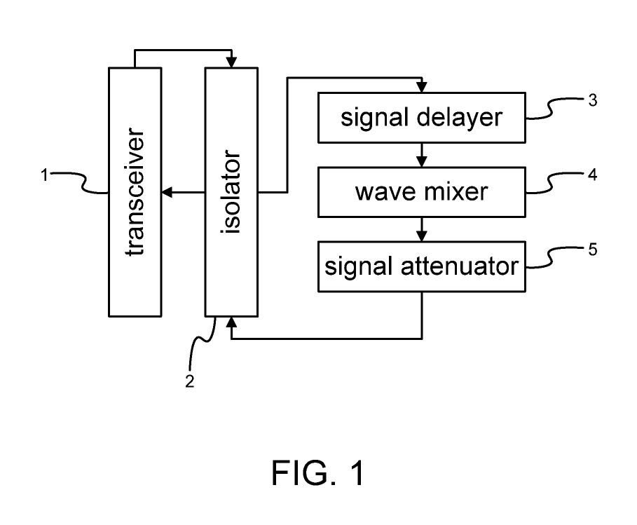

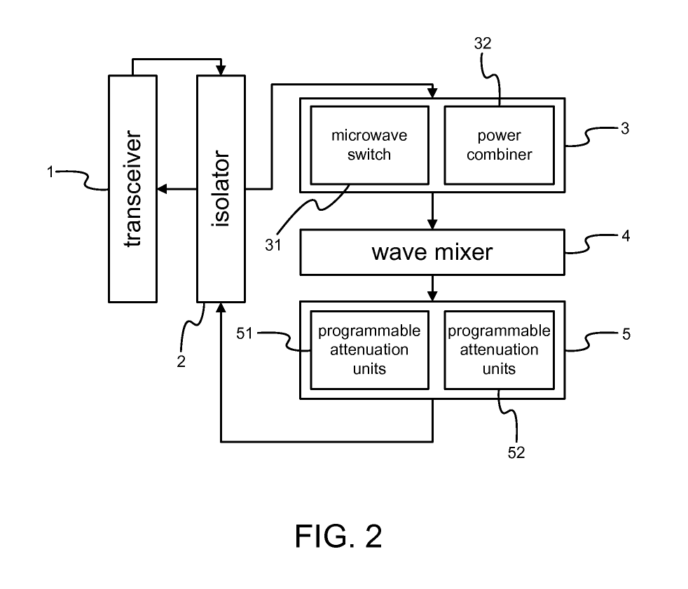

Referring to FIGS. 1 and 2, there is shown an apparatus for simulating a target at a variable distance and speed according to a first embodiment of the present invention. The apparatus includes a transceiver 1, isolators 2, a signal delayer 3, a wave mixer 4 and a signal attenuator 5. The transceiver 1 is used to transmit a signal to the isolators 2. The signal delayer 3 is connected to the isolators 2. The signal delayer 3 is used to receive the signal from the isolators 2 and accordingly simulate a signal delay for a distance. The wave mixer 4 is connected to signal delayer 3. A Doppler shift is introduced into the apparatus via the wave mixer 4. The signal attenuator 5 is connected to isolators 2 and the wave mixer 4. The signal attenuator 5 is used to produce an adjustable attenuated signal corresponding to a variable distance.

The signal delayer 3 includes a microwave switch 31 and a power combiner 32. The microwave switch 31 is a 1-to-4 microwave switch for connection to four different delaying wires. The power combiner 32 is a 4-to-1 power combiner.

The wave mixer 4 receives the signal from the signal delayer 3. The wave mixer 4 further receives the Doppler shift.

The signal attenuator 5 includes at least two programmable attenuation units 51 and 52. The programmable attenuation unit 51 is set to be 10 dB per notch. The programmable attenuation unit 52 is set to be 1 dB per notch.

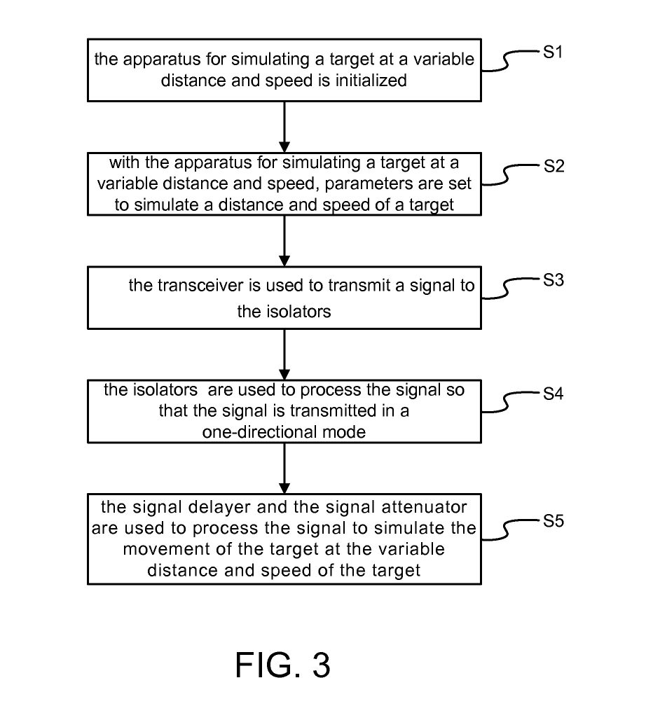

Referring to FIG. 3, there is shown a method for simulating a target at a variable distance and speed according to a second embodiment of the present invention.

At S1, the apparatus for simulating a target at a variable distance and speed is initialized.

At S2, with the apparatus for simulating a target at a variable distance and speed, parameters are set to simulate a distance and speed of a target. The parameters include the distance, speed and acceleration of the target.

At S3, the transceiver 1 is used to transmit a signal to the isolators 2.

At S4, the isolators 2 are used to process the signal so that the signal is transmitted in a one-directional mode.

At S5, the signal delayer 3 and the signal attenuator 5 are used to process the signal to simulate the movement of the target at the variable distance and speed of the target. The signal includes a Doppler shift.

### EXAMPLE 1

In the apparatus for simulating a target at a variable distance and speed, there is reserved a wire of 1 meter equivalent to the air medium. The 1-to-4 microwave switch 31 is connected to four delaying wires to simulate distances of 5 meters, 10 meters, 15 meters and 20 meters before it is connected to the 4-to-1 power combiner 32, i.e., a reversed power distributer. The spatial energy attenuation value is consistent with an RF circuit module. A standard radar equation is used to estimate the attenuation value throughout the entire path. Based on the signal, an attenuation controller is used to set a programmable attenuation unit of 110 dB (10 dB per notch) and another programmable attenuation unit of 11 dB (1 dB per notch) to achieve a needed attenuation value. The wave mixer 4 is used to introduce the Doppler shift for a speed simulation test. Finally, the isolators 2 are used to transmit the signal in a one-directional manner. The signal could not be transmitted in a one-directional manner should there be no isolator 2 for signal path isolation because the transmission and receipt of signals via a radar is non-directional.

The standard radar equation is used to estimate the signal attenuation value in the space. The signal attenuation value is at an inverse proportion to the quartic of the distance. The standard radar equation is expressed as follows:

$${P}_{RX} = \frac{{P}_{TX} {G}_{T} {G}_{R} {λ}^{2} σ}{{( 4 π )}^{3} {R}^{4} L}$$

wherein P_{TX} stands for transmission power, G_{T} and G_{R} respectively stand transmission and receipt gains, λ stands for the wavelength of a carrier wave, σ stands for RCS, R stands for the distance of the target from the radar, and L stands for system attenuation including the wire attenuation.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An apparatus for simulating a target at a variable distance and speed including:
a transceiver 1;
isolators 2 for receiving a signal from the transceiver 1;
a signal delayer 3 for receiving the signal from the isolators 2 and accordingly simulating a delay value for a distance;
a wave mixer 4 connected to the signal delayer 3, wherein a Doppler shift is introduced into the apparatus through the wave mixer 4; and
a signal attenuator 5 connected to the isolators 2 and the wave mixer 4 for producing an adjustable attenuated signal corresponding to a variable distance.

2. The apparatus for simulating a target at a variable distance and speed according to claim 1, wherein the signal delayer 3 includes a microwave switch 31 and a power combiner 32.

3. The apparatus for simulating a target at a variable distance and speed according to claim 2, wherein the microwave switch 31 is a 1-to-4 microwave switch 31 for connection to four wires corresponding to four different distances.

4. The apparatus for simulating a target at a variable distance and speed according to claim 2, wherein the power combiner 32 is a 4-to-1 power combiner.

5. The apparatus for simulating a target at a variable distance and speed according to claim 1, wherein the wave mixer 4 receives the signal from the signal delayer 3 and further receives a Doppler shift.

6. The apparatus for simulating a target at a variable distance and speed according to claim 1, wherein the signal attenuator includes two programmable attenuation units.

7. The apparatus for simulating a target at a variable distance and speed according to claim 6, wherein one of the programmable attenuation units is set to be 10 dB per notch while the other programmable attenuation unit is set to be 1 dB per notch.

8. A method for simulating a target at a variable distance and speed including the steps of:
providing an apparatus with a transceiver 1, isolators 2, a signal delayer 3, and a signal attenuator 5;
initializing the apparatus;
setting parameters with the apparatus to simulate the distance and speed of the target;
using the transceiver 1 to transmit a signal;
using the isolators 2 to facilitate the transceiver 1 to transmit the signal in a one-way directional manner; and
processing the signal to simulate the movement of the target.

9. The method for simulating a target at a variable distance and speed according to claim 8, wherein the parameters include the distance, speed and acceleration of the target.

10. The method for simulating a target at a variable distance and speed according to claim 8, wherein the step of processing the signal includes the step of providing a signal delayer 3 and a signal attenuator 5 for processing the signal.

11. The method for simulating a target at a variable distance and speed according to claim 8, wherein the step of processing the signal includes the step of processing a Doppler shift.
